(19) United States
(12) Patent Application Publication
(10) Pub. No.: US 2011/0099775 A1
(43) Pub. Date: May 5, 2011

(54) WIRING CLIP

(75) Inventors: CHIA-SHIN CHOU, Tu-Cheng (TW); ZHEN-XING YE, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/764,922

(22) Filed: Apr. 21, 2010

(30) Foreign Application Priority Data
Nov. 5, 2009 (CN) 200910309345.4

(51) Int. Cl. F16B 2/20

(52) U.S. Cl. 24/489

(57) ABSTRACT

A wiring clip includes a seat and a pressing member. The seat has a first end and a second end opposite to the first end. The pressing member includes a fixing end pivotally connected to the first end of the seat, a clipping end engaging with the second end of the seat and a pressing body between the fixing end and the clipping end. Two spaced sheets extend upwardly from the second end of the seat, and two hooks extend inwardly from inner side surfaces of the two sheets. The clipping end defines a first opening, the two hooks extend through the first opening and clasp two sides defining the first opening.

### BACKGROUND

1. Technical Field

The disclosure relates to wiring clips and, particularly, to a wiring clip capable of conveniently clipping wires.

2. Description of Related Art

Generally, computers or servers have wiring clips to organize wires electrically connecting electronic elements. A conventional wiring clip includes an elongated sheet defining several through holes at two ends thereof, and several screws engaging with the sheet, thereby fixing the wiring clip to an enclosure of a computer. In use, wires are disposed between the sheet and the enclosure, and the screws are extended through the through holes of the sheet and screwed in the enclosure, thereby fixing the wires to the enclosure. However, having the wiring clip fixed to the enclosure by several screws complicates assembly and disassembly.

What is needed, therefore, is a convenient wiring clip.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a un-buckled view of a wiring clip in accordance with an exemplary embodiment of the disclosure.

FIG. 2 is an enlarged view of a circled portion II of FIG. 1.

FIG. 3 is an inverted view of FIG. 1.

FIG. 4 is a buckled view of the wiring clip shown in FIG. 1.

FIG. 5 is an enlarged view of a circled portion V of FIG. 4.

### DETAILED DESCRIPTION

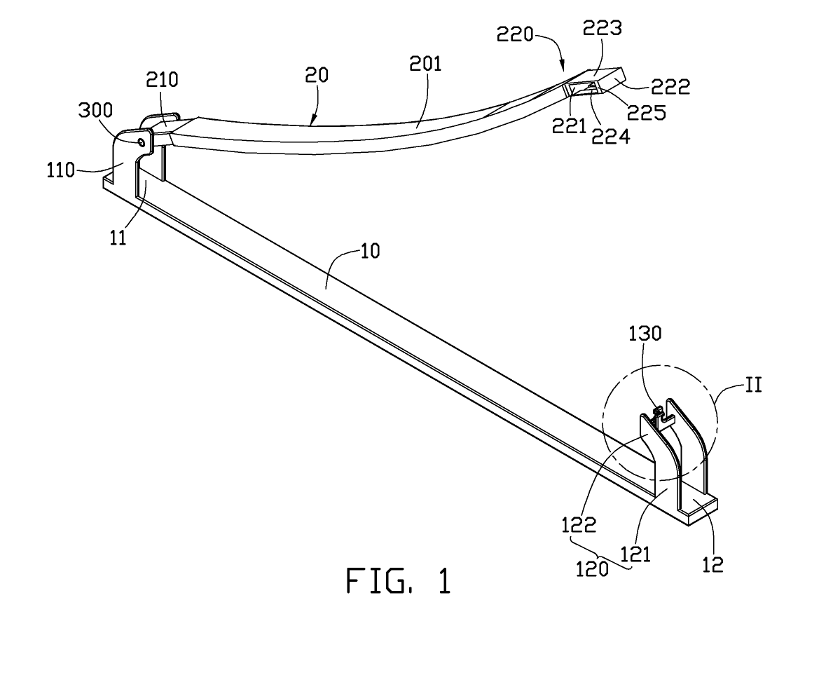

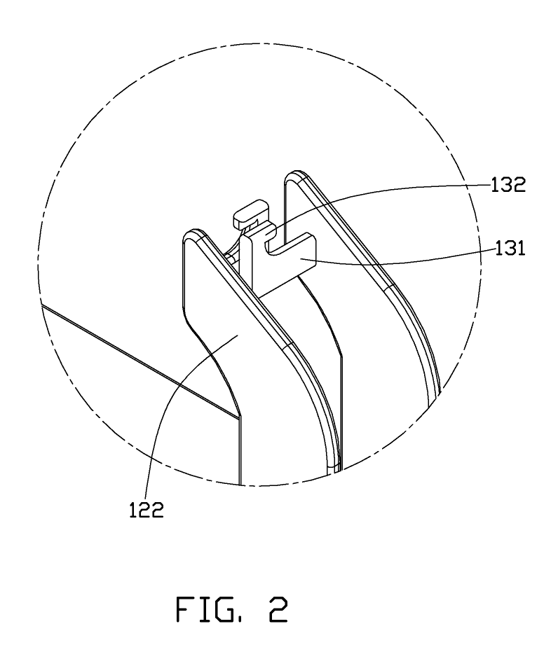

Referring to FIGS. 1-2, an exemplary embodiment of a wiring clip includes an elongated seat 10 and a pressing member 20 engaged with the seat 10. The wiring clip can be applied in computers or servers to organize wires or cables therein. In the present embodiment, the wiring clip is used to fix wires of a computer to an enclosure of the computer.

The seat 10 is fixed to the enclosure of the computer and includes a first end 11 and a second end 12 opposite to the first end 11. Two parallel first sheets 110 extend upwardly from the first end 11 of the seat 10, and another two parallel second sheets 120 extend upwardly from the second end 12 of the seat 10. The pressing member 20 includes a fixing end 210 engaging with the first end 11, a clipping end 220 engaging with the second end 12, and an elastic pressing body 201 between the fixing end 210 and the clipping end 220. The pressing body 201 is an arc-shaped sheet and arches towards the seat 10. A combination structure of the two first sheets 110 has a rigid characteristic to allow a reliable engagement with the fixing end 210 of the pressing member 20. A pivotal shaft 300 spans between the two first sheets 110, and the first end 210 is pivotally connected between the two first sheets 110 through the pivotal shaft 300. Besides the pivotal shaft 300, the first end 210 can be connected to the first end 11 of the seat 10 by other pivotal or rotatable structures, so long as the pressing body 201 of the pressing member 20 can be movable or rotatable relative to the seat 10 to thereby adjust the wires therebetween. On other embodiment, the pressing member 20 and the seat 10 can be made one piece, with the first end 210 of the pressing member 20 integrally connected to the first end 11 of the seat 10.

A combination structure of the two second sheets 120 has an elastic characteristic to allow elastic engagement with the clipping end 220 of the pressing member 20. Each of the two second sheets 120 includes a supporting section 121 extending from an edge of the second end 12 of the seat 10 and an operating section 122 extending towards the first end 11 of the seat 10 from a free end of the supporting section 121. A distance between two supporting sections 121 of the two second sheets 120 is as long as or shorter than a width of the second end 12 of the seat 10. Two opposite hooks 130 respectively protrude inwardly from the two operating sections 122. Specifically, the two hooks 130 respectively extend from inner side surfaces of the two operating sections 122, and are alternated with each other along a lengthwise direction of the operating section 122. Each of the hooks 130 includes a horizontal section 131 extending from the inner side surface of the operating section 122 and an inverted L-shaped hooking body 132 extending upwardly from a free end of the horizontal section 131. The horizontal section 131 is half as long as a distance between the two operating sections 122. The two hooking bodies 132 of the two hooks 130 locate at a middle line of the two operating sections 122 and extend towards opposite directions with each other, respectively.

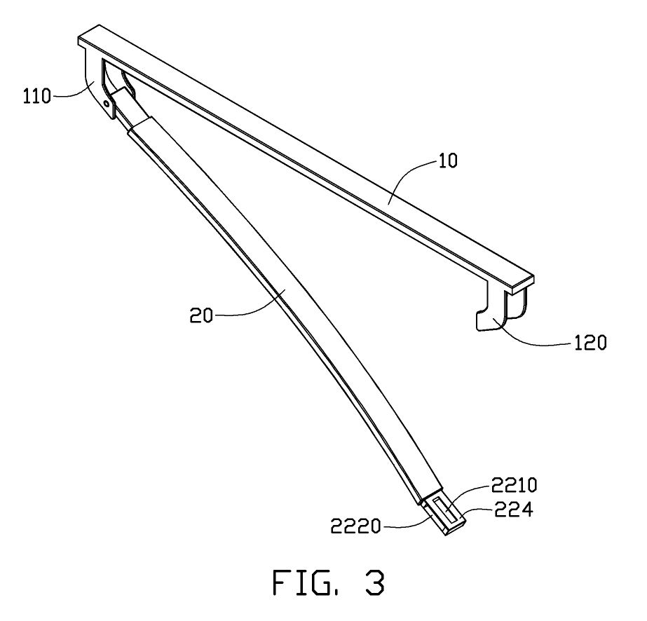

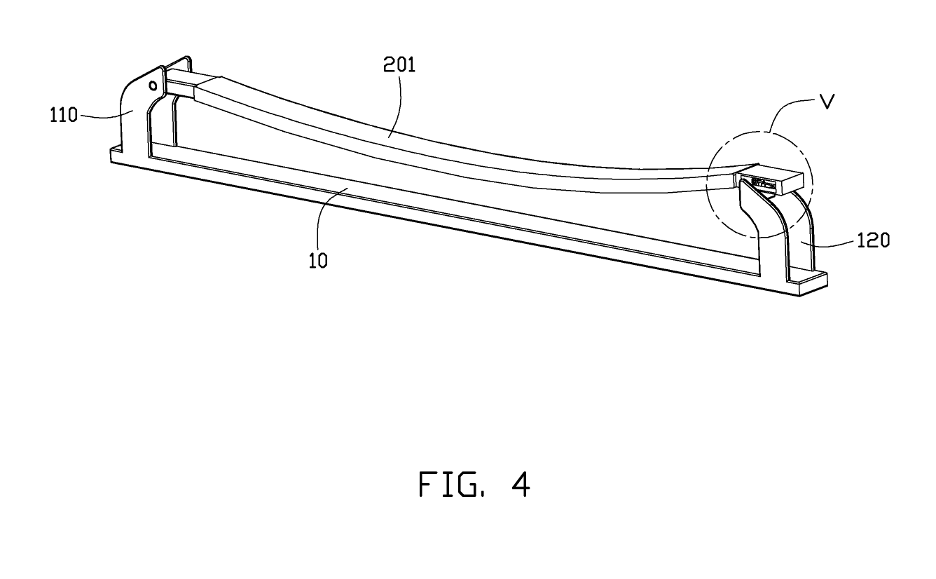

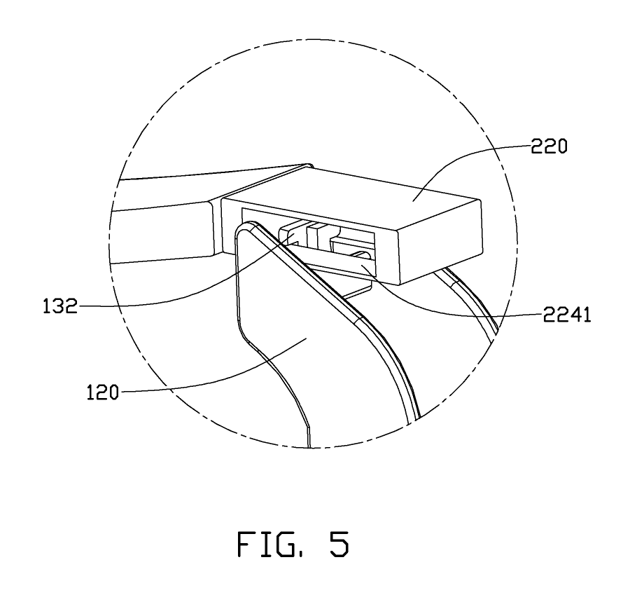

The clipping end 220 has a rectangular configuration and has a rectangular space, which is bounded by a first wall 221 connecting with the pressing body 201, a second wall 222 opposite to the first wall 221, a top wall 223, a bottom wall 224, and two opposite third walls 225. The top and bottom walls 223, 224 respectively adjoin top and bottom edges of the first and second walls 221, 222, and the two third walls 225 respectively adjoin right and left edges of the first and second walls 221, 222. Referring also to FIGS. 3-5, the bottom wall 224 defines a rectangular first opening 2210 to divide the bottom wall 224 into two bottom sheets 2241. The first opening 2210 communicates with the space of the clipping end 220. Each of the two third walls 225 defines a second opening 2220 communicating with the space of the clipping end 220. The two hooking bodies 132 of the two hooks 130 are inserted into the space of the clipping end 220 from the first opening 2210, and then clasp edges defining the two second openings 2220, respectively. In the present embodiment, the two hooking bodies 132 of the two hooks 130 clasp the two bottom sheets 2241 of the bottom wall 224 of the clipping end 220, respectively. A width of the clipping end 220 is as long as or shorter than a distance spanned between the two operating sections 122, whereby the clipping end 220 can be arranged between the two operating sections 122 and engages with the two hooks 130.

In addition, the clipping end 220 is not limited to be the above-described hollow enclosure. In an alternative embodiment, the clipping end 220 is only the bottom wall 224, when the two hooks 130 are engaged with the clipping end 220, the two hooking bodies 132 of the two hooks 130 extend through the first opening 2210 and clasp two sides defining the first opening 2210, respectively. In another alternative embodiment, the clipping end 220 is a solid structure, which defines a first opening allowing the two hooking bodies 132 extending therethrough and two second openings extending towards two opposite sides of the first opening. The first opening and the two second opening cooperatively form a T-shaped groove in the solid structure. When the two hooks 130 engage with the clipping end 220, the two hooking bodies 132 enter the T-shaped groove of the solid structure from the first opening and engage in the two second openings, respectively.

It is understood that structure and number of hooks 130 can be varied and the clipping end 220 engaging with the hooks 130 can be varied accordingly, so long as the hooks 130 enter the space of the clipping end 220 from the first opening 2210 and clasp the edges defining the two second openings 2220 respectively.

In fixing wires, the seat 10 is fixed on the enclosure of the computer, the wires are disposed on the seat 10, and the pressing member 20 is moved downwardly to enable the pressing body 201 to contact the wires. The clipping end 220 is disposed between the two operating sections 122 of the two second sheets 120 with the first opening 2210 corresponding to the two hooks 130. The clipping end 220 is pressed downwardly in such a manner that the hooking bodies 132 of the two hooks 130 enter the space of the clipping end 220 from the first opening 2210 and clasp the edges defining the two second openings 2220, respectively. Due to the engagement of the hooks 130 with the clipping end 220, the pressing body 201 of the pressing member 20 is moved further downwardly to press the wires disposed on the seat 10, thereby fixing the wires between the pressing member 20 and the seat 10.

When the wires need adjusting, the two operating sections 122 are pressed inwardly to enable the two hooking bodies 132 move out of the space of the clipping end 220, and then the pressing body 201 springs away from the wires. Clearly, the pressing member 20 and the seat 10 can be conveniently assembled to or dissembled from each other, thereby facilitating the wiring clip being fixed or released.

It is to be understood, however, that even though numerous characteristics and advantages of the present embodiments have been set forth in the foregoing description, together with details of the configurations and functions of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

1. A wiring clip comprising:
a seat having a first end and a second end opposite to the first end; and
a pressing member comprising a fixing end connected to the first end of the seat, a clipping end to engage with the second end of the seat and a pressing body between the fixing end and the clipping end;
wherein two spaced sheets extend upwardly from the second end of the seat, two hooks extend inwardly from inner side surfaces of the two sheets, the clipping end defines a first opening, the two hooks extend through the first opening and clasp two sides defining the first opening.

2. The wiring clip of claim 1, wherein the clipping end comprises a bottom wall defining the first opening.

3. The wiring clip of claim 1, wherein the clipping end is a rectangular configuration and defines a rectangular space, which bounded by a first wall connecting with the pressing body, a second wall opposite to the first wall, a top wall, the bottom wall, and two opposite third wall, the first opening communicates with the space, each of the third wall defines a second opening communicating with the space, the two hooks are inserted in the space from the first opening, and clasp edges defining the two second openings, respectively.

4. The wiring clip of claim 3, wherein the two hooks extend towards opposite directions, respectively.

5. The wiring clip of claim 4, wherein each of the hooks comprises a horizontal section extending from the inner side surface of the corresponding sheet and an inverted L-shaped hooking body extending upwardly from a free end of the horizontal section, the horizontal section is half as long as a distance between the two sheets, the two distal ends of the hooking bodies extend towards opposite directions, respectively.

6. The wiring clip of claim 5, wherein the two hooking bodies of the two hooks alternate with each other along an imaginary middle line between the two sheets.

7. The wiring clip of claim 1, wherein the pressing body of the pressing member is an arc-shaped sheet and arches towards the seat.

8. A wiring clip comprising:
a seat; and
a pressing member pivotally connected to a first end of the seat, the pressing member comprising a clipping end to engage with an opposite second end of the seat;
wherein a plurality of hooks are disposed on the second end of the seat, the clipping end of the pressing member defines a first opening, the hooks extend through the first opening and clasp edges defining the first opening.

9. The wiring clip of claim 8, wherein two spaced sheets protrude upwardly from the second end of the seat, an inner side surface of each of the two sheets protrudes inwardly a plurality of horizontal sections and a plurality of inverted L-shaped hooking bodies extending upwardly from a free end of the corresponding horizontal sections, the two distal ends of the hooking bodies extend towards opposite directions, respectively.

10. The wiring clip of claim 9, wherein each of the horizontal sections is half as long as a distance between the two sheets.

11. The wiring clip of claim 10, wherein the hooking bodies locates at an imaginary middle line between the two sheets.

12. The wiring clip of claim 8, wherein the clipping end comprises a bottom wall defining the first opening.

13. The wiring clip of claim 8, wherein the clipping end is a rectangular configuration and defines a rectangular space, which bounded by a first wall connecting with the pressing body, a second wall opposite to the first wall, a top wall, the bottom wall, and two opposite third wall, the first opening communicates with the space, each of the third wall defines a second opening communicating with the space, the hooks are inserted in the space from the first opening, and clasp edges defining the two second openings, respectively.

14. The wiring clip of claim 8, wherein the pressing body of the pressing member is an arc-shaped sheet and arches towards the seat.
